(19) United States
(12) Patent Application Publication
(10) Pub. No.: US 2014/0362983 A1
(43) Pub. Date: Dec. 11, 2014

(54) Community Service System And Related Method

(71) Applicant: Wei-Wen Hsu, New Taipei City (TW)

(72) Inventor: Wei-Wen Hsu, New Taipei City (TW)

(21) Appl. No.: 14/279,342

(22) Filed: May 16, 2014

(30) Foreign Application Priority Data
Jun. 7, 2013 (TW) 102120264

(51) Int. Cl. H04M 3/44

(52) U.S. Cl. CPC H04M 3/44
USPC 379/216.01

(57) ABSTRACT

The community service system contains a community module, a residential module data-linked with a community module, a client device data-linked with the residential module, and a service provider module delivering advertisement fee and service information to the community module. The service access device contains a provider unit and a single-click dialing unit corresponding to the provider unit. A user can use a client device to link with the residential module, look up required services, select a desired provider unit, and activate a single-click dialing unit to dial the service provider. As such, the present invention achieves easy operation, fast synchronization, convenient search, and speedy dialing for e-management of a community.

### BACKGROUND OF INVENTION

(a) Technical Field of the Invention

The present invention is generally related to community services, and more particularly to a community service system and a related method of easy operation, fast synchronization, convenient search, and speedy dialing for e-management of a community.

(b) Description of the Prior Art

A residential community or an apartment building (hereinafter, a community), there is usually a management committee whose members are elected from the residents. Constantly, for the management of the community, the management committee needs to communicate with the residents such as for the collection of management fees, utility usage data, etc. The management committee usually delivers notes to each resident, post notification on a billboard, or visit each resident, which are all time consuming and inefficient.

On the other hand, a resident often requires information about the management committee's contracted service providers, so as to gain services such plumbing, repairmen, calling cabs, etc. If the resident is not satisfied with the service, the resident has to find another service provider himself or herself, which again is time consuming and inefficient.

### SUMMARY OF THE INVENTION

Therefore, a novel community service system and a related method is provided that is capable of easy operation, fast synchronization, convenient search, and speedy dialing for e-management of a community.

A major objective of the present invention is to provide service provider information to community residents.

Another objective of the present invention is to deliver information quickly and efficiently.

Yet another objective of the present invention is to make usage even simpler and more quickly.

To achieve the objectives, the community service system contains a community module, at least a residential module, at least a client device, and at least a service provider module. The residential module contains at least an information device and at least a service access device. The residential module is data-linked to the community module and allows update and modification by the community module. The service access device contains at least a provider unit and at least a single-click dialing unit corresponding to the provider unit. The client device is data-linked with the residential module so as to access the information device and the service access device. The service provider module transmits advertisement fee and service information about a service provider to the community module. The service provider module corresponds to a provider unit and a single-click dialing unit. After the service provider module pays advertisement fee to the community module, the community module transmits the service information of the service provider module to the service access devices of all resident modules. A corresponding provider unit and a corresponding single-click dialing unit are then produced accordingly. A user then can use a client device to link with the residential module, look up required services, select a desired provider unit, and activate a single-click dialing unit to dial the service provider. As such, the present invention achieves easy operation, fast synchronization, convenient search, and speedy dialing for e-management of a community.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a community service system according to an embodiment of the present invention.

FIG. 2A is a schematic diagram showing service access devices of the community service system on a client device.

FIG. 2B is a schematic diagram showing the provider units and the single-click dialing units presented by a service access device of the community service on a client device.

FIG. 3A is a schematic diagram showing information devices of the community service system on a client device.

FIG. 3B is a schematic diagram showing a data entry device of the community service system on a client device.

FIG. 3C is a schematic diagram showing an announcement reception device of the community system on a client device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

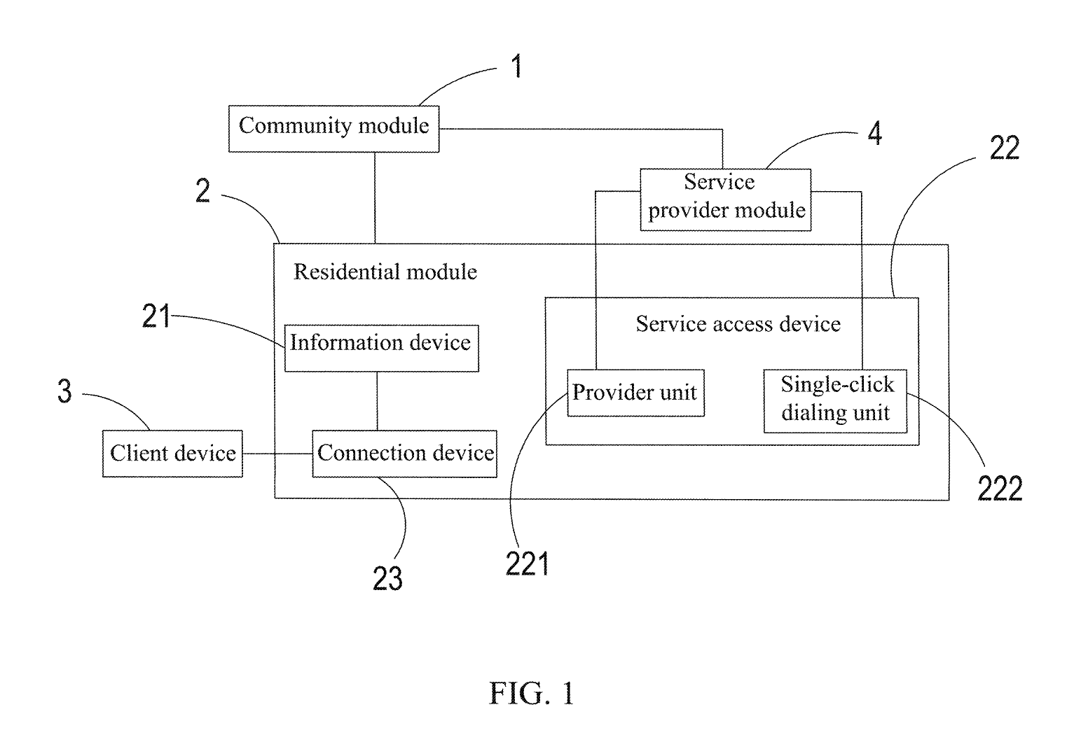

FIG. 1 is a functional block diagram showing a community service system according to an embodiment of the present invention. As illustrated, the community service system contains a community module 1, at least a residential module 2, at least a client device 3, and at least a service provider module 4. The residential module 2 contains an information device 21, a connection device 23, and a service access device 22. The residential module 2 is data-linked to the community module 1 and allows update and modification by the community module 1. The information device 21 is one of an announcement reception device, a message sending device, and a data entry device, clearly arranged. The service access device 22 is one of a discount device, a traffic device, a shopping device, a repairmen device, a cosmetic device, and a food device, clearly arranged. The service access device 22 contains at least a provider unit 221 and at least a single-click dialing unit 222 corresponding to the provider unit 221. The client device 3 can be one of an intercom, a telephone set, a computer, a tablet computer, and a cellular phone. The client device 3 is data-linked with the residential module 2 so as to access the information device 21 and the service access device 22.

The connection device 23 is for the client device 3′s connection to the residential module 2. The service provider module 4 corresponds to a provider unit 221 and a single-click dialing unit 222. The service provider module 4 transmits advertisement fee and service information to the community module 1 where the service information contains an address, a telephone number, a discount information, a sales campaign, a special offer of the service provider module 4. The single-click dialing unit 222 allows the client device 3 to conduct one-click dialing to the service provider module 4.

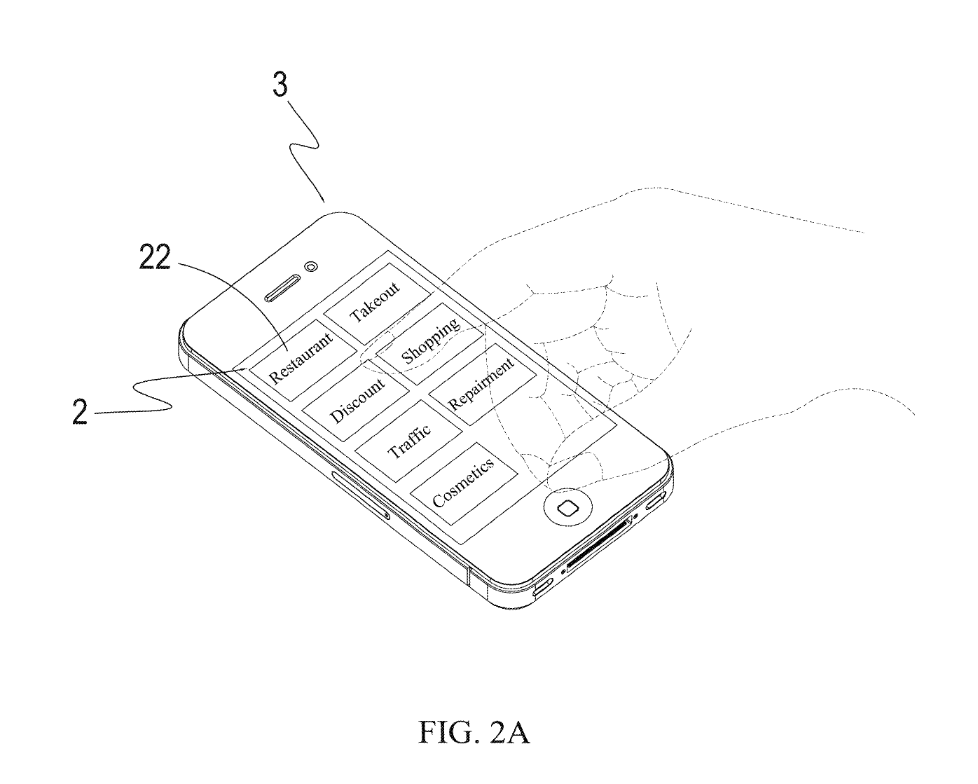

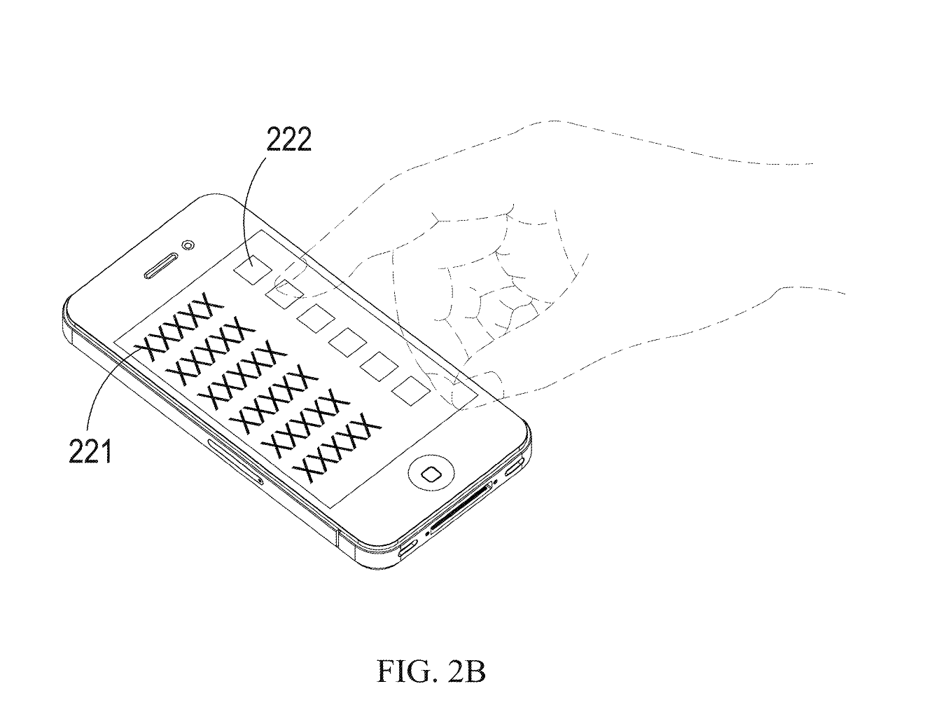

After the service provider module 4 pays advertisement fee to the community module 1, the community module 1 transmits the service information of the service provider module 4 to the service access devices 22 of all resident modules 2. A corresponding provider unit 221 and a corresponding single-click dialing unit 222 are then produced accordingly. As shown in FIG. 2A, when a user uses a client device 3 to link with the residential module 2 through the connection device 23, the user is able to look up the required services (e.g., calling a cab, repairmen, restaurant reservation, order out, etc.), select a desired provider unit 221, and activate a single-click dialing unit 222 to dial the service provider, as shown FIG. 2B.

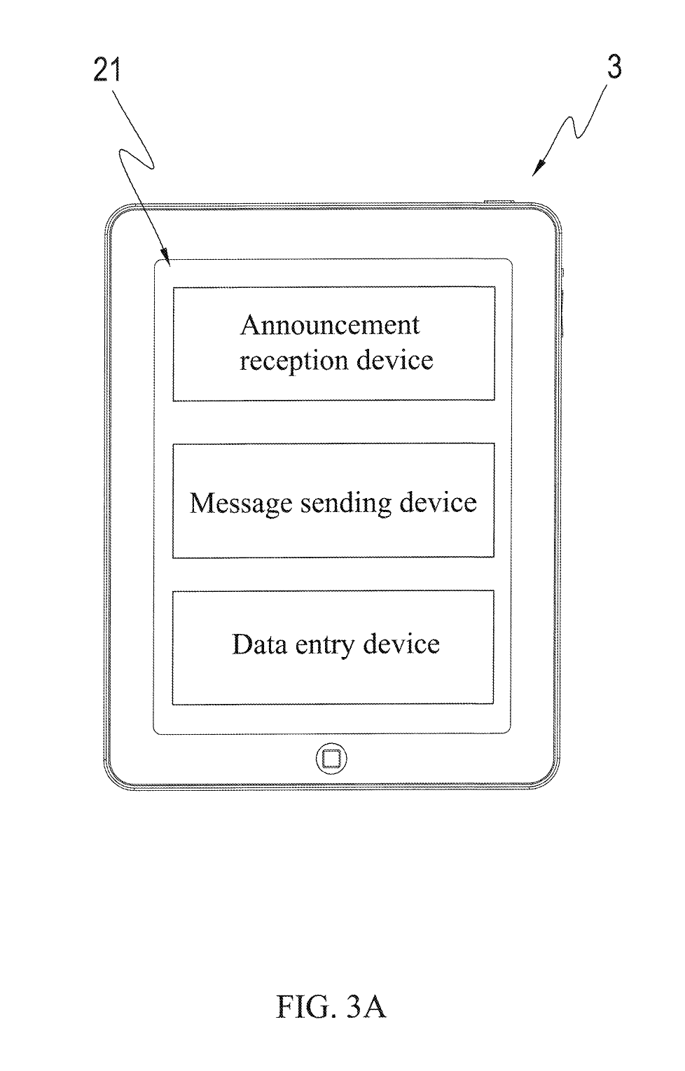

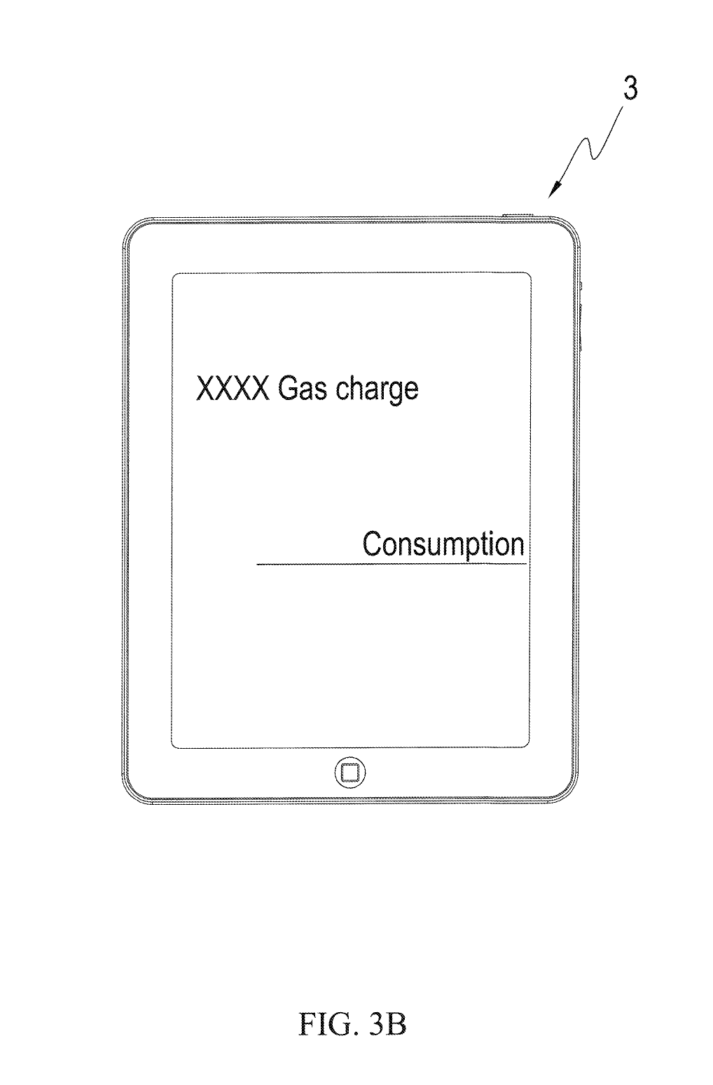

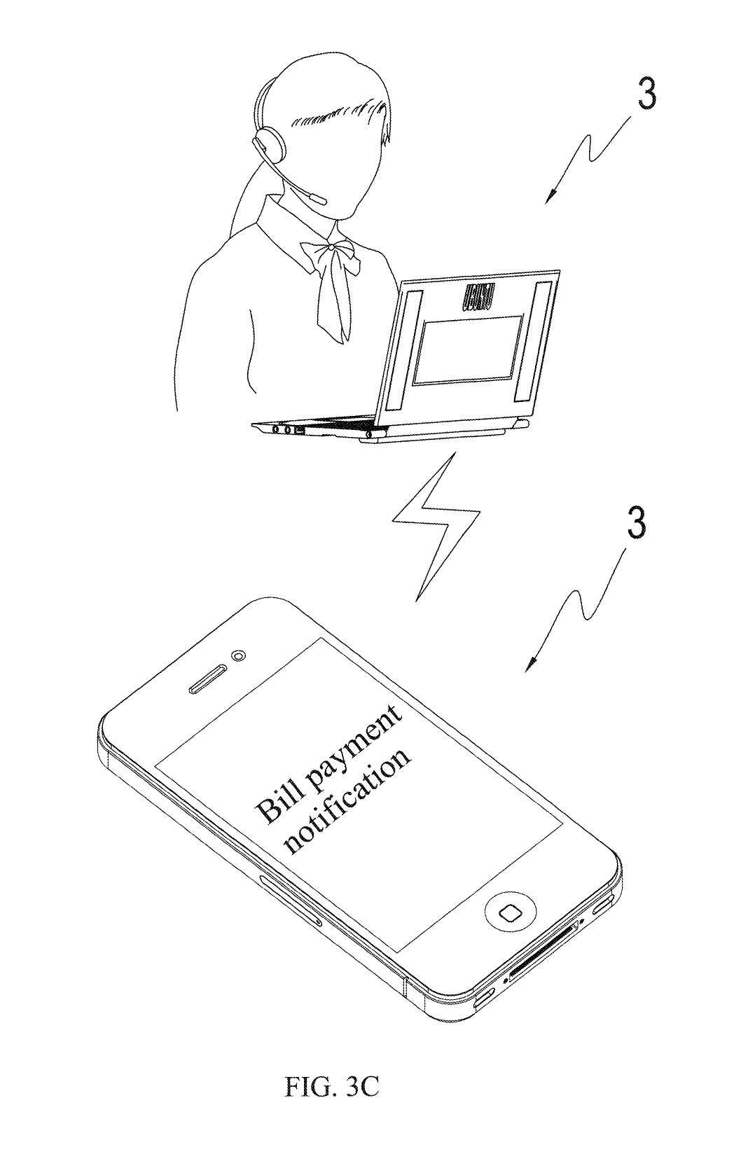

Additionally, as shown in FIG. 3A, a user selects and activates a function provided by the information device 21. For example, the user can register the current utility meter data of his/her house or apartment (as shown in FIG. 3B) through a client device 3, or the user can post or deliver information through the information device 21 to another client device 3 (as shown in FIG. 3C).

As described above, the major features of the community service system and the related method are as follows.

First, the provider unit 221 and the single-click dialing unit 222 of the service access device 22 provides enhanced usage convenience and efficiency.

Secondly, the arrangement of the information device 21 and the service access device 22 offers greater operation simplicity and search convenience. Thirdly, the integration of the information device 21 and the service access device 22 achieves e-management for a community.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A community service system, comprising:
at least a community module;
at least a residential module data-linked with the community module to receive update and modification;
at least an information device configured in the residential module;
at least a service access device configured in the residential module where the service access device comprises at least a provider unit and at least a single-click dialing unit corresponding to the provider unit;
at least a client device data-linked with the residential module so as to access the information device and the service access device; and
at least a service provider module corresponding to the provider unit and the single-click dialing unit where the service provider module transmits advertisement fee and service information to the community module.

2. The community service system according to claim 1, wherein the single-click dialing unit provides the client device single-click dialing to the service provider module for speedy operation.

3. The community service system according to claim 1, wherein the resident module further comprises a connection device for the client device to link to the residential module; the information device is one of an announcement reception device, a message sending device, and a data entry device; and the service access device is one of a discount device, a traffic device, a shopping device, a repairmen device, a cosmetic device, and a food device.

4. The community service system according to claim 1, wherein the service information comprises one of an address, a telephone number, a discount information, a sales campaign, a special offer of the service provider module.

5. The community service system according to claim 1, wherein the client device is one of an intercom, a telephone set, a computer, and a cellular phone.

6. A community service method, comprising:
after at least a service provider module pays advertisement fee to at least a community module, the community module transmitting service information of the service provider module to at least a service access device of at least a resident module;
the service access device creating a corresponding provider unit and a corresponding single-click dialing unit according to the service information;
at least a client device linking at least an information device in the residential module; and
the client device accessing the information device or the provider unit of the service access device, and activating the single-click dialing unit.

7. The community service method according to claim 6, wherein the single-click dialing unit provides the client device single-click dialing to the service provider module for speedy operation.

8. The community service method according to claim 6, wherein the resident module further comprises a connection device for the client device to link to the residential module; the information device is one of an announcement reception device, a message sending device, and a data entry device; and the service access device is one of a discount device, a traffic device, a shopping device, a repairmen device, a cosmetic device, and a food device.

9. The community service method according to claim 6, wherein the service information comprises one of an address, a telephone number, a discount information, a sales campaign, a special offer of the service provider module.

10. The community service method according to claim 6, wherein the client device is one of an intercom, a telephone set, a computer, and a cellular phone.
